(19) United States
(12) Patent Application Publication
(10) Pub. No.: US 2004/0184719 A1
(43) Pub. Date: Sep. 23, 2004

(54) Apparatus and method for reducing oscillations in an optical system

(75) Inventor: Mansur B. Kiadeh, Cupertino, CA (US)

Correspondence Address: BURGESS & BEREZNAK LLP, 800 WEST EL CAMINO REAL, SUITE 180, MOUNTAIN VIEW, CA, 94040, US

(73) Assignee: Lightbay Networks Corporation, Fremont, CA

(21) Appl. No.: 10/769,160

(22) Filed: Jan. 30, 2004

Related U.S. Application Data
(63) Continuation-in-part of application No. 10/171,298, filed on Jun. 13, 2002.
(60) Provisional application No. 60/298,488, filed on Jun. 14, 2001.

(51) Int. Cl. G02B 6/26; G02B 6/42

(52) U.S. Cl. 385/18

(57) ABSTRACT

Unwanted dynamics in an optical switch are eliminated by calculating a set of new parameter values that shape an input command signal applied to the switch in accordance with an algorithm that randomly varies initial parameter values within certain constraints. The input command signal is applied to the mirror actuators in order to produce a response by the optical switch. A cost function value indicative of oscillations present in the response is calculated and compared to a previous cost function value. If the cost function value is less than the previous cost function value, the new parameter values are stored and designated as the initial parameter values for a next iteration. Following repeated iterative calculations to shape the input command signal, an optimal set of parameter values are produced. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### RELATED APPLICATIONS

This application is a continuation-in-part application of Ser. No. 10/171,298 filed Jun. 13, 2002 entitled, “PHOTONIC SWITCHING APPARATUS FOR OPTICAL COMMUNICATION NETWORK”.

### FIELD OF THE INVENTION

The present invention relates generally to apparatus and methods for reshaping input commands in a control system; more specifically, the invention relates to apparatus and methods for eliminating unwanted resonances to speed up switching time in optical systems and networks.

### BACKGROUND OF THE INVENTION

Fiberoptic technologies and systems have been widely deployed in recent decades. However, certain key components remain expensive and inefficient, which hinders the expansion of optical systems and optical communication networks. One of these components is the wavelength switch, which routes and redirects a light beam from one fiber to another fiber so that the signal can be provisioned and managed according to the demand. A typical wavelength switch used today converts the input light signal into an electronic signal to detect the routing information, switches the electronic signal, and then eventually reconverts it back into a light signal for further transmission. This device, commonly referred to as an Optical-Electrical-Optical (OEO) switch, not only depends on current semiconductor technologies and processes, but also requires a transmitter and a receiver for each transmission port. These factors cause OEO switches to be large in size (e.g., occupying two or more 7-foot tall racks), to have high power consumption (e.g., kilowatts), to be network protocol and transmission rate dependent, to lack scalability, and to be costly.

Another problem with prior art optical systems is unwanted dynamics such as mechanical resonances that can adversely affect system performance. For instance, mechanical oscillations that occur in an optical switch can cause mirror alignment inaccuracies, which can reduce optical output intensity and slow switching performance.

Thus, there is a need for an alternative apparatus for directing a light beam in an optical system that can be manufactured efficiently and provide improved performance in optical systems and fiber optic-based networks. There is also a need for apparatus and methods to reduce mechanical oscillations and resonances to thereby improve optical performance.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a top perspective view of an actuator-mirror matrix assembly utilized in accordance with one embodiment of the present invention.

FIG. 2 is a perspective view of an actuator-mirror matrix assembly utilized in accordance with an embodiment of the present invention.

FIG. 3 is a perspective view of an actuator-mirror bar assembly utilized in accordance with one embodiment of the present invention.

FIGS. 4A & 4B are top views of a gimbal used in accordance with one embodiment of the present invention.

FIG. 5 illustrates a platform that mounts to the gimbal of FIGS. 4A & 4B in an actuator-mirror assembly according to one embodiment of the present invention.

FIG. 6 is a bottom perspective view of an integrated mirror/pedestal 210 utilized in accordance with one embodiment of the present invention.

FIG. 7 illustrates an actuator-mirror assembly at an intermediate point of construction.

FIG. 8 illustrates an actuator-mirror assembly at a further point of construction.

FIG. 9 is a perspective view of an actuator-mirror assembly.

FIGS. 10A & 10B are top and side views of a magnet-housing arrangement for an actuator-mirror assembly utilized in accordance with one embodiment of the present invention.

FIG. 11 is a top view of a magnet-housing arrangement for an actuator-mirror assembly utilized in accordance with another embodiment of the present invention.

FIG. 12 is a cross-sectional side view of an actuator-mirror assembly.

FIGS. 13A & 13B are cross-sectional side views of an actuator-mirror assembly tilted in two different directions in accordance with one embodiment of the present invention.

FIGS. 14 is an exploded side view of a portion of the exemplary actuator-mirror matrix assembly of FIG. 2.

FIG. 15 illustrates a photonic switch module utilized in accordance with one embodiment of the present invention.

FIG. 16 is a block diagram of an open loop control system for positioning a mirror of a photonic switch in accordance with one embodiment of the present invention.

FIG. 17 is a block diagram of an open loop control system for positioning a mirror of a photonic switch in accordance with another embodiment of the present invention.

FIG. 18 is a high-level block diagram is an example of an electronics circuit that may be used for control of a photonic switch according to the present invention.

FIG. 19 is a plot that depicts the effect of ramp profile shaping and/or pre-filtering on an input command signal used to position a mirror in accordance with one embodiment of the present invention.

FIG. 20 is a frequency response curve of a notch filter utilized in accordance with one embodiment of the present invention.

FIG. 21 is a functional block diagram of the open loop control system utilized to eliminate mechanical oscillations according to one embodiment of the present invention.

FIG. 22 illustrates an example of a folded large-matrix photonic switch fabric layout in accordance with one embodiment of the present invention.

FIG. 23 is a flowchart of a tuning algorithm utilized in accordance with one embodiment of the present invention.

FIG. 24 is a block diagram of a closed loop system for reducing resonances in a laser projector according to another embodiment of the present invention.

FIG. 25 is a schematic illustration of an implementation of a PID controller utilized in the system of FIG. 24.

### DETAILED DESCRIPTION

An apparatus and method for eliminating unwanted mechanical oscillations in an optical system is described. In the following description numerous specific details are set forth, such as electronic devices, material types, configurations, etc., in order to provide a thorough understanding of the present invention. However, persons having ordinary skill in the opto-electronics arts will appreciate that these specific details may not be needed to practice the present invention.

According to one embodiment of the present invention, a control system that eliminates unwanted mechanical resonances in a photonic switch fabric (e.g., an all-optical switch) utilizing a tilting actuator-mirror assembly is provided. Such optical switches have numerous other consumer, medical, and/or industrial applications. For example, laser marking, optical scanning devices, windshield auto projection, helmet display, personal digital assistant (“PDA”) and mobile phone projection display, to name a few, can all benefit from the present invention.

In one implementation, an optical switch light is guided by a fiber through a collimator, which forms the divergent light rays into a round beam having a specific beam width, onto a first mirror. The first mirror is part of an actuator-mirror assembly that can be tilted to reflect the light beam onto a second mirror. The second mirror is also part of an actuator-mirror assembly that is used to tilt the mirror along x and y-axes. A plurality of actuator-mirror assemblies is arranged in a matrix in which rows or columns of actuator-mirror assemblies are attached to one or more connector bars. The number of actuator-mirror assemblies on a connector bar and the number of bars per matrix depends on the particular application, for example, the port count of a switch.

According to one embodiment, a photonic switch utilizing a dual-axis tilting actuator is provided as a rotary moving coil actuator suspended by a flexing, electrically conductive gimbal component. The gimbal is comprised of a pair of beams that move about the axis of rotation under the influence of an electromagnetic actuator. The conductive connections in the rotary moving coil actuator are integrated with the flexing part of the gimbal. In various embodiments, the actuator may rotate about either a single axis or a dual axis.

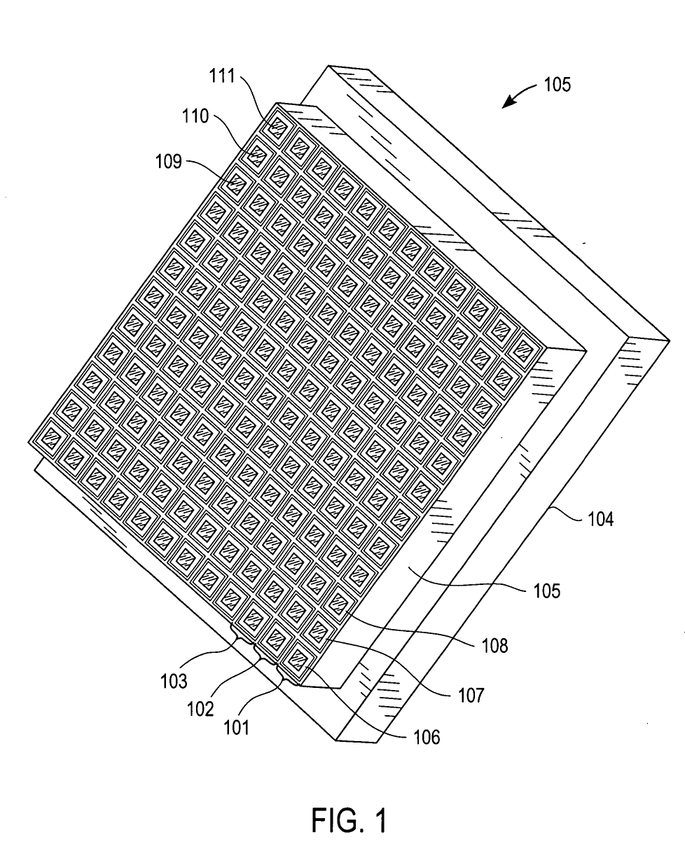

FIG. 1 is a perspective view of an actuator-mirror matrix assembly 105 in accordance with one embodiment of the present invention. By way of example, actuator-mirror matrix assembly 105 may be used as a photonic switch for fiber optic communication applications. A photonic switch is typically used to provision the path of light in a fiber optic communication network.

In the example of FIG. 1, assembly 105 includes actuator-mirror bars (e.g., 101, 102, 103, etc.), each of which comprises two rows of individual actuator-mirror assemblies (e.g., mirror assemblies 106-111, etc.). The actuator-mirror bars are supported by a platform 104 that may also provide electrical connection to the individual actuators. In the particular embodiment shown, platform 104 comprises an aluminum block that supports the bars and also facilitates connection of the bars to a printed circuit board assembly. Matrix assembly 105 comprises six actuator-mirror bars, with each of the bars including 2 rows of 12 mirror plates per row (2×12), for a total of 144 mirror plates, which is sufficient to support a 72-port photonic switch. Each of the individual actuator-mirror assemblies includes a mirror plate that provides a highly reflective surface utilized to direct a laser beam, or other light beam.

It is appreciated that the number of actuator-mirror assemblies included on an actuator-mirror bar (i.e., the number of rows and columns) may vary, depending, for example, upon the port count of the photonic switch, or other system application.

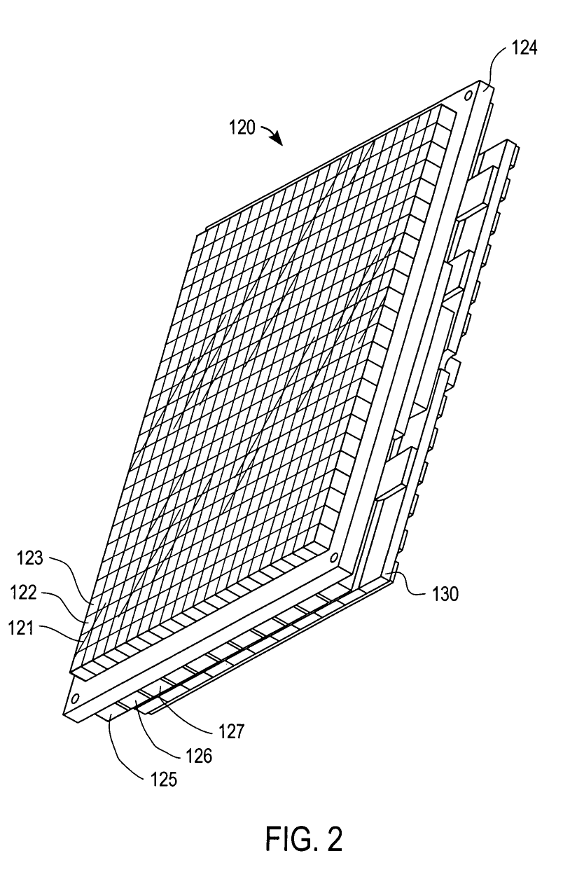

FIG. 2 is a perspective view of an actuator-mirror matrix assembly 120 in accordance with another embodiment of the optical switch fabric. Individual actuator-mirror bars (125, 126, 127, etc.) are shown mounted to a platform 124. Each bar supports two rows of actuator-mirror assemblies (121, 122, 123, etc.). The reflective surface of each mirror faces outward in the matrix assembly of FIG. 2. A printed circuit board assembly (“PCBA”) 130 is coupled to the underside of each of the bar assemblies 125, 126, 127, etc. to drive and control the actuators. The PCBA includes current driver integrated circuits (“IC's”) and multiplexing circuitry that reduce the number of pin connections between the actuator-mirror matrix assembly 120 and a main PCB (not shown in this view). In the example shown in FIG. 2, gaskets or some other seal or packing may be included between the bars and the platform frame 124 to seal the assembly.

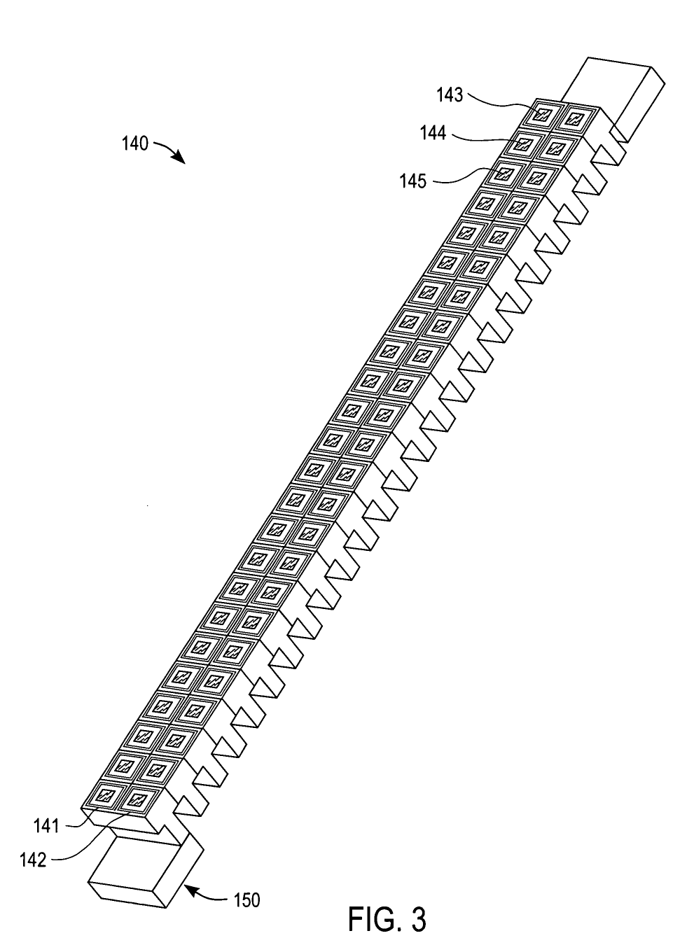

FIG. 3 is a perspective view of a single actuator-mirror bar assembly 140 (and platform portion 150) that may be utilized to implement the matrix assembly of FIG. 2. Bar assembly 140 comprises a support bar 150 that supports two columns (i.e., 141 & 142) by twenty-four rows of individual actuator-mirror assemblies (143, 144, 145, etc.) for a total of forty-eight actuator-mirror assemblies. The number of the actuator-mirror assemblies and the number of bar assemblies per matrix (shown in FIGS. 1 & 2) depend on the particular application. For instance, if the actuator-mirror bar assembly 140 were to be used in an all-optical switch of a fiber communication network, the number of actuator-mirror assemblies included on each bar would depend on the port count of the switch.

Each of the actuator-mirror assemblies includes subassemblies, such as a mirror-gimbal assembly. These subassemblies may include the actuator wiring and the actuator power drivers. In some applications, the actuator-mirror assemblies may comprise rotary moving coil-object assemblies suspended by a flexing gimbal component that allows the mobile coil-object assembly to move in a desired manner.

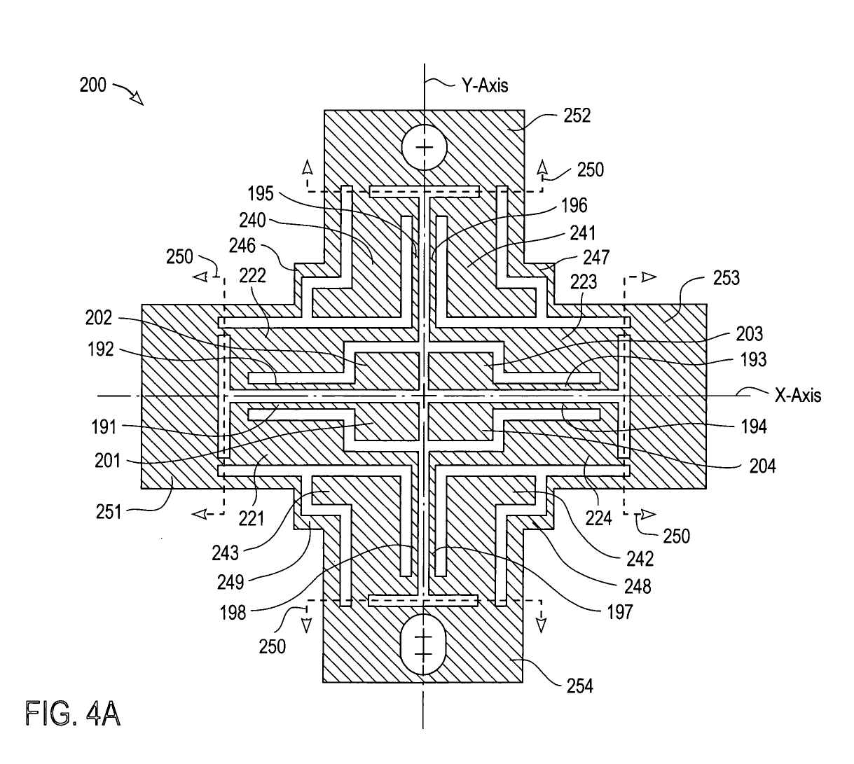

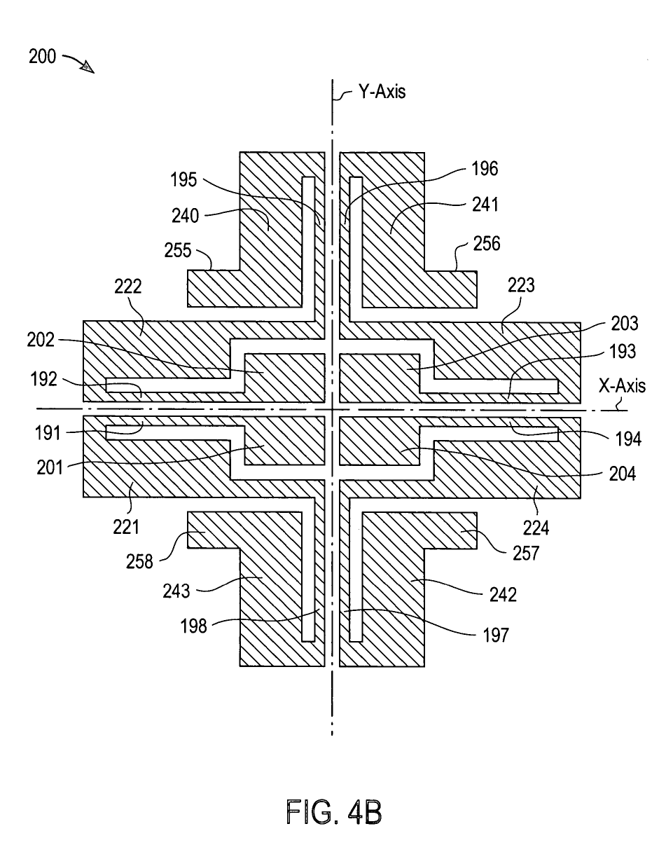

Referring now to FIGS. 4A & 4B, there is shown a top plan view of a gimbal 200 utilized in accordance with one embodiment of the present invention. Gimbal 200 is made from a single, integral sheet of thin metal. FIG. 4A shows gimbal 200 after removal of the “cutout” areas from the sheet metal. FIG. 4B shows the gimbal after removal of the end section and perimeter material, which step may be performed during the construction of the actuator-mirror assembly.

The sheet metal used for gimbal 200 is preferably a fully hardened material, such as stainless steel, having high fatigue strength. Other materials providing similar properties may also be used. The material selected should allow the gimbal to rotate the attached mirror (or mirror-coil assembly) with a high rotational angle (e.g., +/−15 degrees) over millions of movement cycles. The material may also be heat-treated. The sheet metal material is also preferably non-magnetic to prevent reluctance forces induced by the magnets in the actuator. In some cases, the sheet metal may also be coated with a corrosion-resistant material, such as titanium-nickel or gold.

Gimbal 200 comprises four attachment pads 201-204 that are centrally located symmetrical about the x-axis (i.e., longitudinal axis) and y-axis (i.e., transverse axis). A mirror, or mirror-pedestal assembly, is adhesively attached to pads 201-204. Thus, in the completed assembly, pads 201-204 are all affixed in a rigid plane, remaining stationary or moving in unison, depending on the particular embodiment of the final actuator-mirror assembly. Thin, elongated beams 191-194 support each of pads 201-204, respectively. In operation, pairs of adjacent beams 191 & 192 and 193 & 194 each twist longitudinally about the x-axis to permit the mirror (attached to pads 201-204) to rotate about the x-axis.

In FIG. 4A, beams 191 & 192 are shown being integrally connected to end section 251 through respective intermediate sections 221 & 222. Similarly, beams 193 & 194 are integrally connected to end section 253 through intermediate sections 223 & 224, respectively. Intermediate sections 221-224 are also integrally connected with thin, elongated beams 195-198, respectively, which permit rotation of the mirror about the y-axis. During rotation of the mirror about the x-axis, pairs of adjacent beams 195 & 196 and 197 & 198 remain substantially rigid. Similarly, during rotation of the mirror about the y-axis, pairs of adjacent beams 195 & 196 and 197 & 198 twist longitudinally about the y-axis, while pairs of adjacent beams 191 & 192 and 193 & 194 remain substantially rigid.

Beams 195 & 196 are shown in FIG. 4A being connected to end section 252 via respective L-shaped mounting sections 240 & 241. Likewise, beams 197 & 198 are both integrally connected to end section 254 through respective L-shaped mounting sections 242 & 243. All of the end sections 251-254 are attached together through a set of perimeter connecting sections 246-249. For example, end section 251 attaches to end sections 252 & 254 via connecting sections 246 & 249, respectively. End section 253 attaches to end sections 252 & 254 via connecting sections 247 & 248, respectively. In this embodiment, end sections 251-254 (beyond dashed lines 250 in FIG. 4A) are removed along with the perimeter connecting sections during the assembly process. FIG. 4B shows gimbal 200 after these metal sections have been removed. This assembly process of this embodiment is described in more detail below.

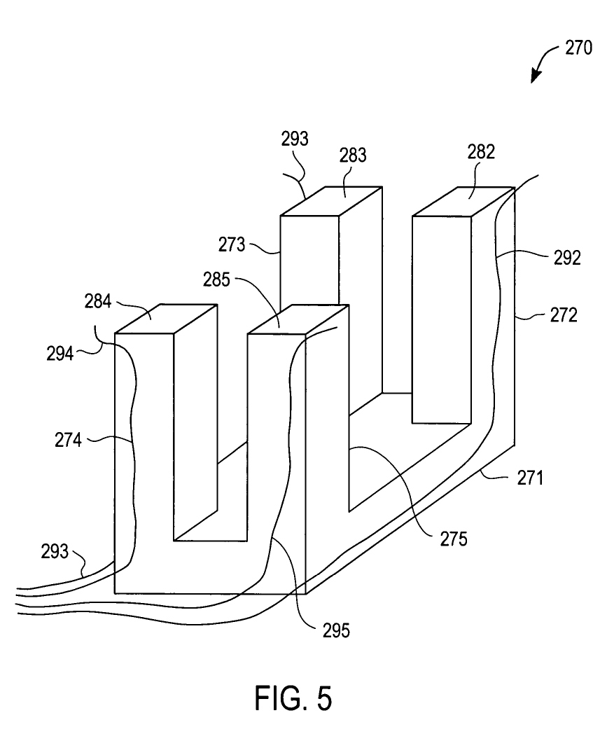

Each of the mounting sections 240-243 of gimbal 200 is fixedly mounted (e.g., with adhesive) to a stationary point or platform mount of the actuator-mirror assembly. FIG. 5 shows one possible implementation of a platform 270 that may be used for this purpose. Platform 270 comprises a base 271 that supports four rigid posts 272-275 of equal height. Each of the posts 272-275 has a flat end surface 282-285, respectively. The dimensions of end surfaces 282-285 and the position of posts 272-275 is such that end surfaces 282-285 align with the rectangular surface areas of mounting sections 240-243 (see FIG. 4B) in a corresponding manner. This permits the mounting sections 240-243 to be adhesively attached to corresponding end surfaces 282-285.

FIG. 5 also shows a set of four thin wires 292-295, each of which is adhesively bonded to respective posts of platform 282-285. These wires connect with the coils that comprise the actuator of the final assembly. Two of the wires are used to energize the coils disposed about the x-axis, and the other two are used to energize the coils disposed about the y-axis.

After gimbal 200 has been mounted to platform 270 each of the wires 292-295 are soldered to corresponding tabs of the mounting sections 240-243. For example, if surface 282 is attached to mounting section 240, wire 292 may be soldered to tab 255. Continuing with this example, with surfaces 283-285 respectively attached to mounting sections 241-243, wires 293-295 may be soldered to tabs 256-258, respectively. Note that in gimbal 200 of FIG. 4B each of tabs 255-258 provides separate electrical connection with respective pads 202, 203, 204, and 201. This feature is utilized to establish electrical connection to the coils of the actuator-mirror assembly, as discussed in more detail shortly.

Metal may be removed from a single piece of thin sheet metal to achieve the gimbal cutout patterns shown in FIGS. 4A & 4B using a variety of conventional methods, such as chemical etching, press cutting, milling, etc. Although a specific rectilinear cutout pattern is shown in these figures, it is understood that other embodiments may have different patterns or a different arrangement of beams, pads, etc., yet still provide rotational movement along the x and y axes.

In the embodiment illustrated by FIGS. 4A & 4B, beams 191-198 are each about 0.05 mm wide, mirror-attachment pads 201-204 are each about 0.4 mm×0.6 mm in dimension, and the thickness of the single piece of sheet metal is about 0.0254 mm. Wires 292-295 are also about 0.0254 mm thick. In certain embodiments, beams 191-198 may be partially etched to make them thinner than the rest of the sheet metal material. For example, beams 191-198 may be chemically etched to a thickness less than 0.0254 mm to increase flexibility and thus achieve a higher degree of rotation.

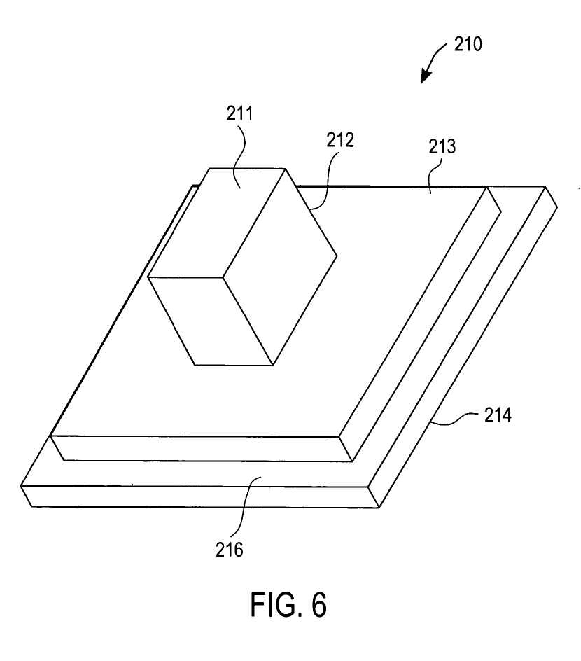

FIG. 6 is a bottom perspective view of an integrated mirror/pedestal 210 utilized in accordance with one embodiment of the present invention. In the drawing, the polished, reflective surface of mirror 214 faces down and into the page. Integrated mirror/pedestal 210 may be manufactured from a single piece of material such as silicon, Pyrex®, quartz, sapphire, aluminum, or other types of suitable materials. Integrated mirror/pedestal 210 includes a pedestal portion 212 having a flat surface 211. The length and width of surface 211 is such that it matches or fit within the combined area of pads 201-204 (see FIG. 4B). During the assembly process, surface 211 is adhesively bonded to one side of pads 201-204.

Integrated mirror/pedestal 210 also includes a base plate 213 between pedestal portion 212 and the back of mirror 214. Base plate is sized smaller than mirror 214 such that a step 216, comprising a peripheral area of the back of mirror 213, is realized. It is appreciated that other embodiments may be constructed from discrete parts (e.g., separate mirror, base plate, and pedestal) rather than being manufactured in integral form. In either approach, the mirror may be about 0.25 mm thick and 2×2 mm in area. The mirror surface may be lapped to a highly polished optical-flat surface. A reflective surface can also be applied by numerous methods, including plating or sputtering gold, silver, or aluminum on a layer of nickel.

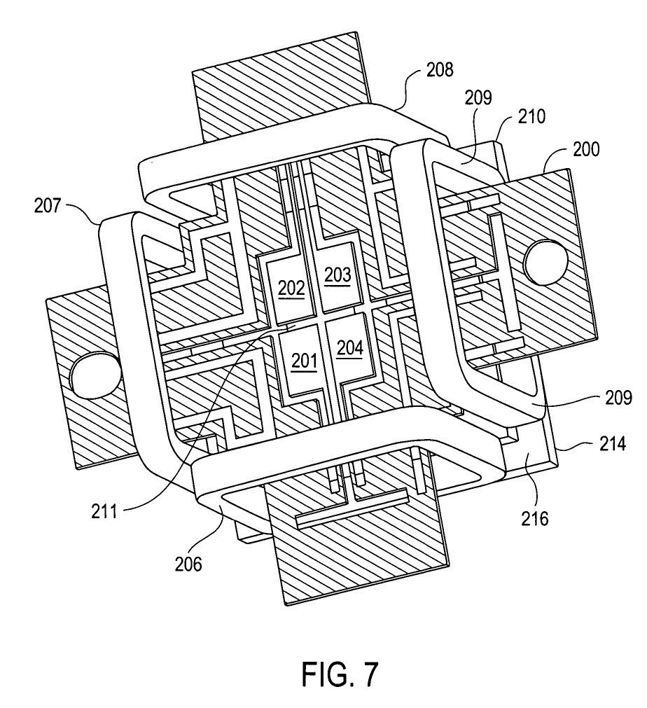

FIG. 7 shows a bottom perspective view of an actuator-mirror assembly after pads 201-204 have been bonded to surface 211 of integrated mirror/pedestal 210. FIG. 7 also shows four coils 206-209 adhesively bonded to step 216 around the side back surface of mirror 214. Thus, coils 206-209, mirror 214, and pads 201-204 of gimbal 200 are all rigidly coupled together, and move as a single unit, in the actuator-mirror assembly presently described. Note that although FIG. 7 shows the end sections of gimbal 200 before removal at this stage of the assembly process, this is not required. That is, the end and peripheral connecting sections of gimbal 200 may be removed either before or after attachment to the mirror/pedestal assembly.

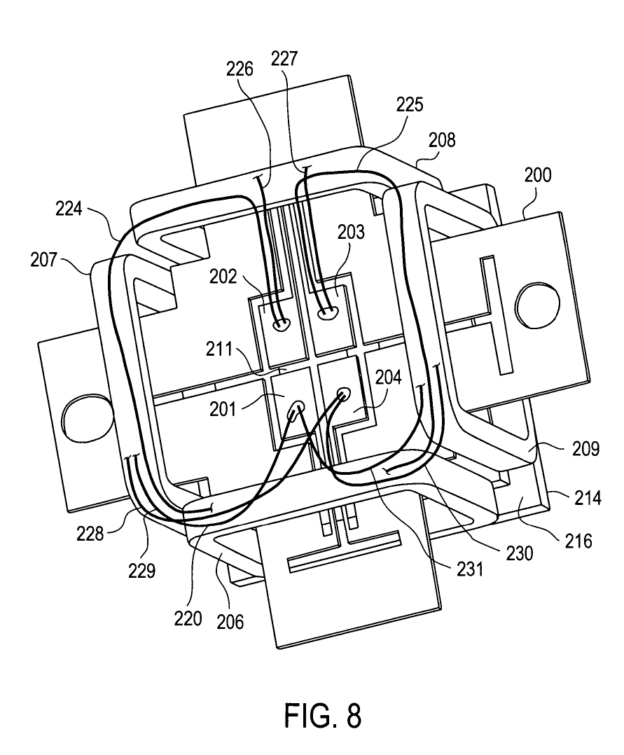

FIG. 8 is another view of the assembly of FIG. 7 after soldering of pairs of coil wires to the back of pads 201-204. (Note that not all of the cutout portions of the gimbal are shown in this view for clarity reasons.) For example, wires 226 & 227 of coil 208, and wires 224 & 225 of coil 206, are shown soldered to pads 202 & 203, respectively. Similarly, wires 228 & 229 of coil 207, and wires 230 & 231 of coil 209, are soldered to pads 204 & 201, respectively.

Upon removal of the end sections of gimbal 200, each of the pads 201-204 is electrically connected to a separate one of the mounting sections 240-243. In other words, removal of the end sections of the gimbal creates four distinct conductive paths in the remaining sheet metal material from each of the four mounting sections to a corresponding one of the pads 201-204. According to one embodiment of the present invention, current flows through these four paths to control movement of the attached mirror via coils 206-209. This embodiment therefore utilizes the metal of gimbal 200 to conduct electrical current delivered to the moving coil. That is, the electrical connections to the coil wires are integrated with the flexing part of the gimbal. This arrangement thereby eliminates movement of wires during operation of the mirror-gimbal assembly.

Following attachment of the gimbal to platform 270 (see FIG. 5) wires 292-295 may be soldered to tabs 255-258 to establish an electrical connection to coils 206-209. Thus, the conductive paths provided through the flexing beams of gimbal 200 may be used to energize the coils in order to control tilting of the mirror along the x-axis and the y-axis. By way of example, one pair of wires 292-295 may be used to energize one pair of opposing coils (i.e., coils 207 & 209) to control rotation of the mirror about the x-axis, with the remaining pair of wires 292-295 being used to energize the other pair of opposing coils (i.e., coils 206 & 208) to control rotation of the mirror about the y-axis. In the final assembly, permanent magnets are attached within the central opening of each of the coils 206-209.

Torque is developed on the mirror-coil assembly upon application of an appropriate current through the coils, in the presence of the permanent magnetic field. The direction of the force is made to be opposite on each side of the mirror-coil assembly such that the resulting torque rotates or tilts the mirror attached to the top of gimbal 200. Since the mirror-coil assembly is fixedly attached to gimbal 200, gimbal pads 201-204 and mirror 214 rotate together as the mirror-coil assembly rotates. When the applied current is interrupted or halted, the restoring spring force of gimbal 200 returns the assembly to a rest position.

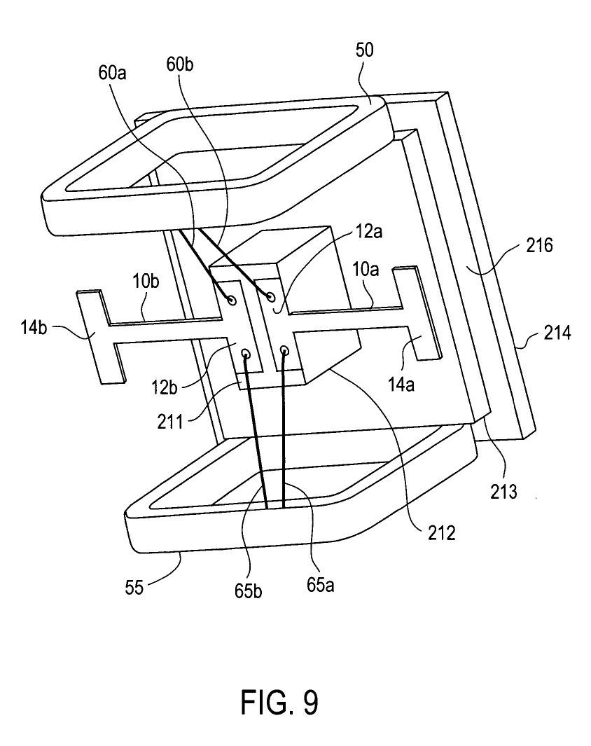

FIG. 9 is a perspective view of another embodiment of an actuator-mirror assembly that may be utilized in accordance with the present invention. The actuator-mirror assembly shown in FIG. 9 rotates about a single axis. In this embodiment, two coils 50 and 55 are adhesively attached to step 216 on opposite sides of mirror 214 and base plate 213. The gimbal for this embodiment comprises two rectilinear, or I-bar, shaped members 10a & 10b of thin sheet metal. Ends 12a & 12b of respective I-bar members 10a & 10b are bonded to surface 211 of pedestal 212. Wires 60a & 60b of coil 50 are soldered to ends 12a & 12b, respectively. Likewise, wires 65a & 65b of coil 55 are also soldered to ends 12a & 12b, respectively. A stationary platform similar to that shown in FIG. 5, but having two posts, supports the assembly of FIG. 9, with the end surfaces of the posts being bonded to ends 14a & 14b of I-bar members 10a & 10b. A wire attached to each of the mounting posts may be soldered to ends 14a & 14b to provide electrical connection through the gimbal members 10a & 10b to energize coils 50 & 55.

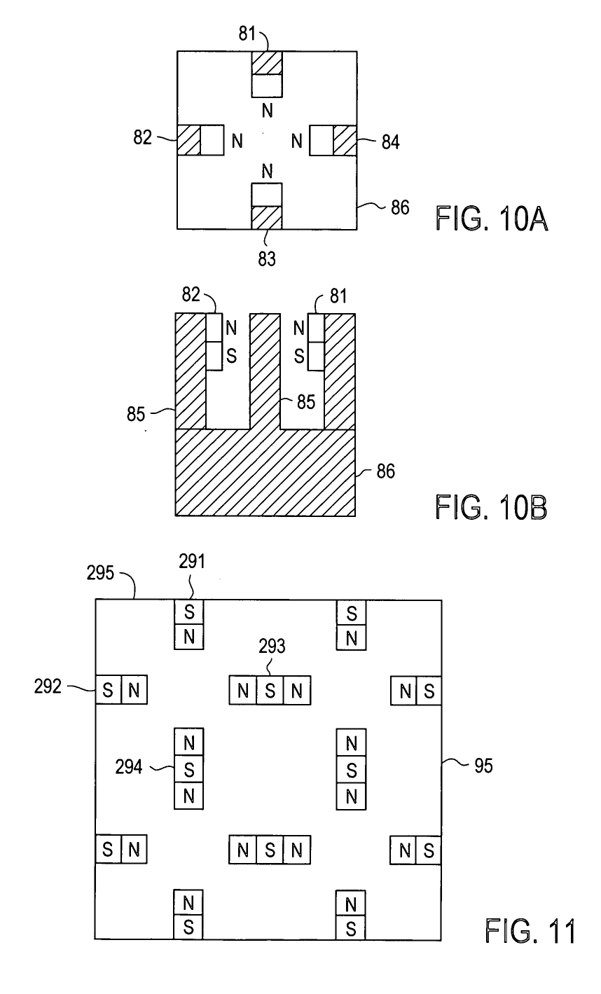

FIGS. 10A & 10B show top and side views of a magnet-housing arrangement for a single actuator-mirror assembly. This magnet-housing arrangement, for example, may be utilized in the actuator-mirror assembly shown in FIG. 7. Magnets 81-84 are bonded on the side surfaces of steel returns 85, attached to a base 86. Magnets 81-84 are positioned adjacent the moving coils (e.g., coils 206-209). The polarities of the magnets are shown by conventional nomenclature for north (N) and south (S). In one embodiment, the magnet material is Neodymium-Iron-Boron. Of course, other types of magnetic materials may be used as well.

FIG. 11 shows a top view of a larger magnet-housing arrangement for use with multiple actuator-mirror assemblies.

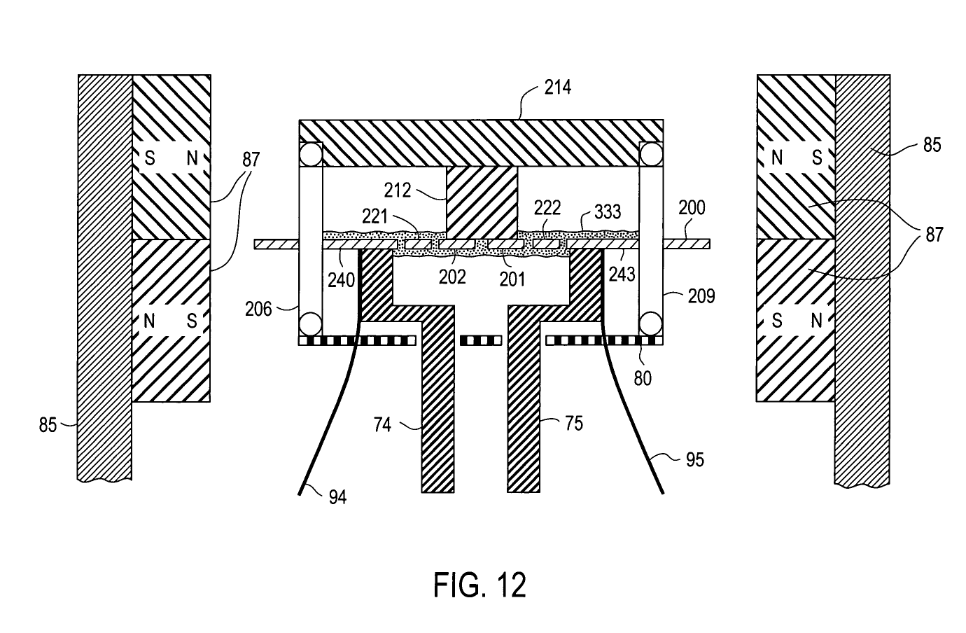

FIG. 12 is a cross-sectional side view of an actuator-mirror assembly utilizing gimbal 200 according to one embodiment of the present invention. A pair of magnets 87 is shown attached to a steel return on opposite sides of the mirror-coil-gimbal assembly. One pair of magnets 87 are positioned adjacent coil 206, and the other pair of magnets 87 are positioned adjacent coil 209. Each of the coils is bonded to a notched edge surface of mirror plate 214. A pedestal 214 is shown attached to the back of mirror plate 214 and also to pads 201 & 202 of gimbal 200. The end surfaces of posts 74 & 75 are shown respectively bonded to mounting sections 240 & 243, with wires 94 & 95 soldered to sections 240 and 243 in accordance with the wiring scheme described above.

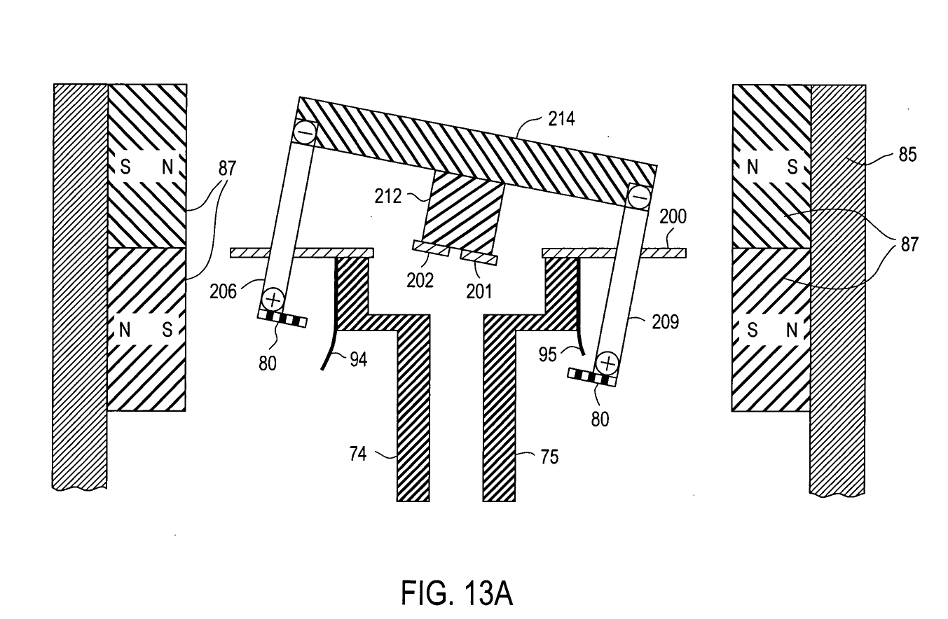

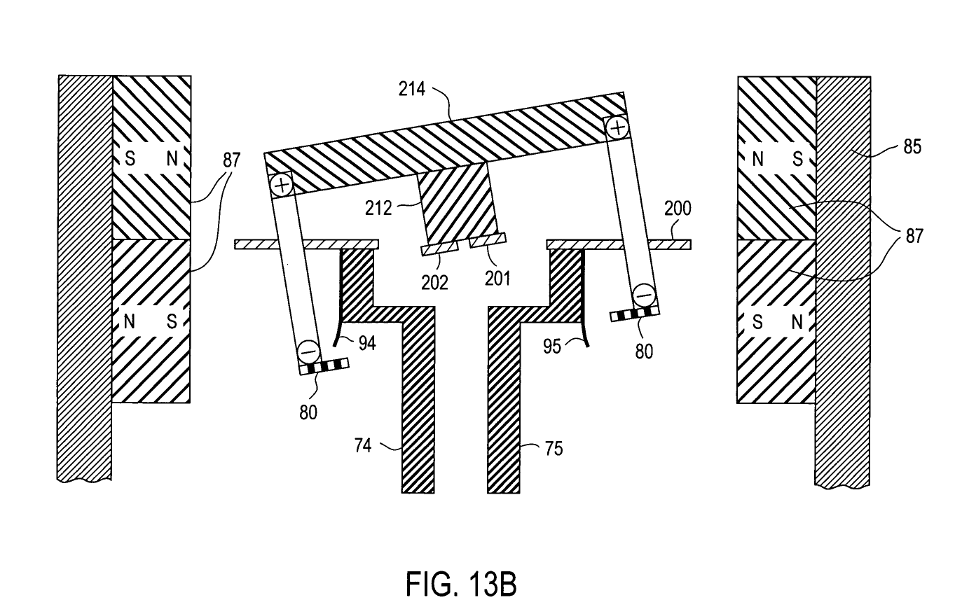

Also included in the cross-section of FIG. 12 is an optional balancing plate 80 attached to the bottom of the coils 206-209. Balancing plate 80 acts to counter-balance the weight of the mirror so that the center of rotation is at the center of gravity. This feature improves external shock and dynamic settling of the actuator. As shown in FIG. 12, balancing plate 80 comprises a solid, flat metal plate with several openings that allow the stationary posts to attach to the gimbal and also permit the gimbal-mirror-coil assembly to move. Instead of having several openings to accommodate mounting of the mirror-coil-gimbal onto stationary posts, balancing plate 80 may also be implemented with a single, centrally located opening. For instance, balancing plate 80 may comprise a rectangular frame having its sides adhesively attached to the coils, as shown in FIGS. 13A & 13B.

The embodiment of FIG. 12 further illustrates the use of an optional damper coating 333, which covers beams 191-198 and gimbal pads 201-204. Damper coating 333 comprises a low viscosity polymer (e.g., an ultraviolet curing resin) that becomes a flexible gel upon curing. Damper coating 333 acts to damp gimbal resonances and improve the settling time of the actuator; yet, because coating 333 is flexible, it does not appreciably affect the stiffness of the gimbal. Damper coating 333 also improves reliability by minimizing the effect of external shock and vibration.

FIGS. 13A & 13B are cross-sectional side views of an actuator-mirror assembly with appropriate current applied to coils 206 & 209 to tilt mirror 214 in two different directions along a single longitudinal axis of movement. Note that in FIGS. 13A & 13B only the rigid sections of gimbal 200 are shown for clarity reasons. Precise movement of mirror 214 along both the x-axis and y-axis is achieved by controlling the current applied to the four coils 206-209 for the embodiments described above.

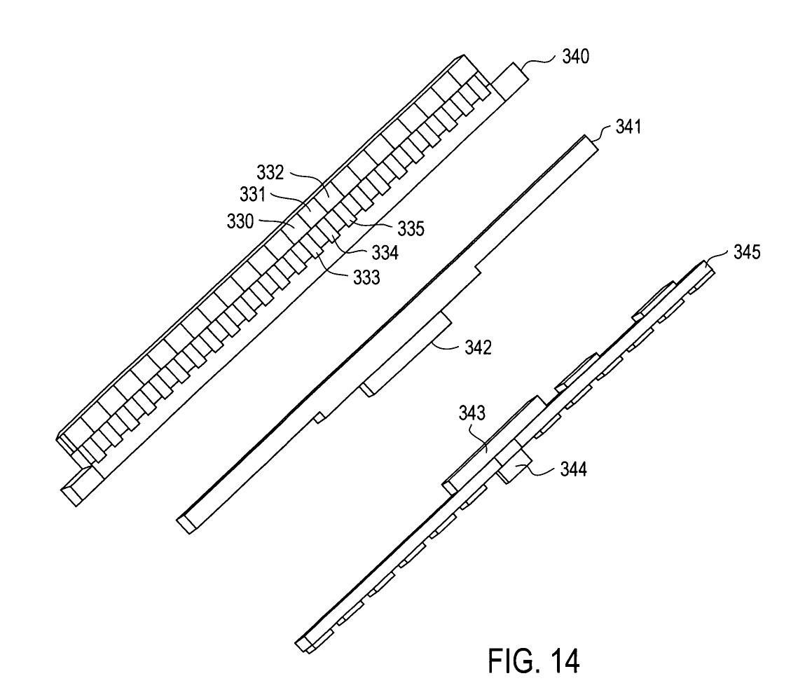

FIG. 14 is an exploded side view of a portion (i.e., a 2×24 bar) of the exemplary actuator-mirror matrix assembly of FIG. 2. Individual actuator-mirror assemblies (e.g., 330, 331, 332, etc.) are shown attached to corresponding actuator flex circuits (e.g., 333, 334, 335, etc.) The flex circuits provide electrical connection to the coils housed in each individual actuator-mirror assembly. The actuator-mirror assemblies and the actuator flex circuits are shown comprising bar assembly 340. An actuator bar connector 341 provides connection between the flex circuits of actuator bar assembly 340 and a printed circuit board assembly (PCBA) 345. The actuator bar flex circuit 341 includes a female pin connector 342 and the PCBA 345 includes a male pin connector 343.

PCBA 345 contains a variety of circuits for driving and controlling the actuator-mirror matrix assembly. Among the various components included on PCBA 345 are current driver IC's and multiplexing circuitry to reduce the number of pin connections between the actuator mirror bar assembly 360 and a main controller or main PCBA (not shown). PCBA 345 also contains a female pin connector 344 for providing power and control signals to PCBA 345 from a main controller or main PCBA. In this example, the PCBA 350 is the same size as the bar. As is described herein, each actuator-mirror assembly may include four coils, two of which are connected in series. Therefore, two dedicated power drivers may be used to drive each actuator-mirror assembly.

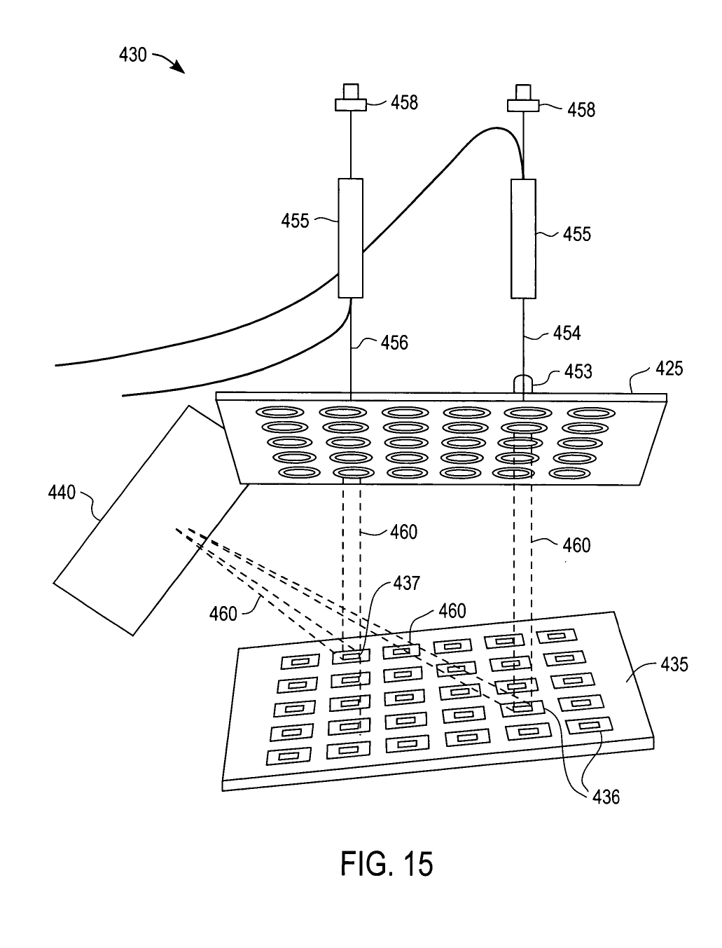

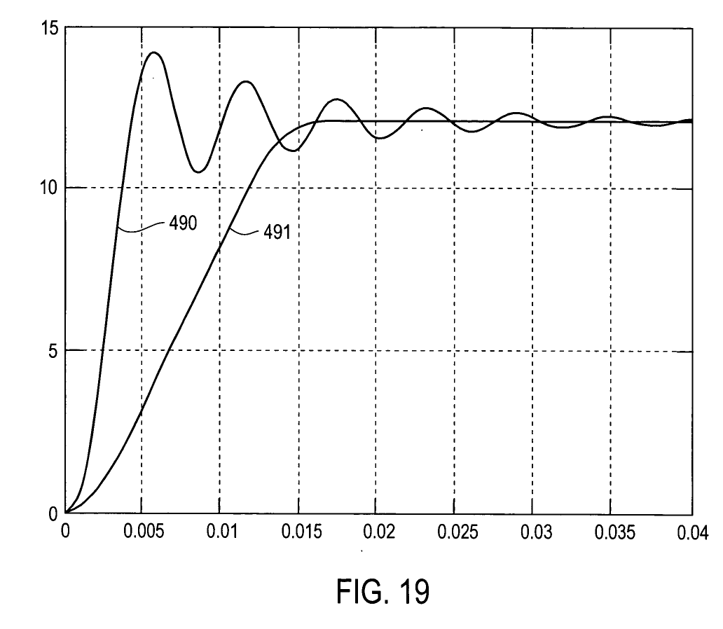

FIG. 15 shows a photonic switch module 430 for use in an optical communication network in accordance with one embodiment of the present invention. The photonic switch module 430 shown in FIG. 15 includes a fiber lens matrix 425, a reference mirror 440, and an actuator-mirror matrix assembly 435, as described above. Fiber lens matrix 425 includes accurately drilled receptor holes. Each of the fiber-lens receptacles functions as an optical port, which, in the described embodiment includes an optical fiber coupler connected to a lens. The input portions of the holes are fitted with a collimator or lens 453 to direct light provided by a fiber optic coupler onto the mirror of an individual actuator-mirror assembly. Each of the lenses 453 acts to collect and collimate the light beams passing through matrix 425. Lens 453 may comprise a gradient index lens, a molded aspherical lens, or some other type of lens known in the art. The embodiment of FIG. 19 may also include an intensity monitoring feedback loop that includes a photodiode to detect a portion of the beam of light, and an optical fiber coupler having a first end connected to an optical fiber and a second end connected to the photodiode.

In the example of FIG. 15, respective input and output optical fibers 454 and 456 are each shown connected to a coupler 455 that is secured to a housing (not shown) by a fiber connector 458. The housing accommodates arrays of input/output fibers for the switch module. Coupler 455 in this example is a 1×2 coupler that passes most of the light signal (e.g., 95%-99%) to the mirror array. A small amount of light (i.e., 1%-5%) is redirected to the photo-detector where it can be amplified and transmitted to a central control center in the main PCBA as part of the signal feedback loop. Fiber lens matrix 425 and actuator-mirror matrix assembly 435 are configured and positioned such that each input/output fiber receptacle of matrix 425 is precisely aligned with a corresponding mirror of assembly 435. Each lens 453, therefore, is associated with a dedicated actuator-mirror assembly 436.

To ease the impact of beam divergence and reduce signal loss of the light beam, the diameter of the collimator lens 453 is chosen dependent upon the overall traveling distance of the light beam switched from input fiber 454 to output fiber 456. A mirror of a first actuator-mirror assembly 436 functions to direct a light beam 460 received from fiber 454 to a reference mirror 440. Reference mirror 440 then reflects light beam 460 to a destination mirror 437 of a second actuator-mirror assembly. Mirror 437 functions to redirect light beam 460 to output fiber 456. Reference mirror 440 and the mirrors of assemblies 436 may be coated with a reflective layer in gold or aluminum to provide high reflectivity (e.g., 98%).

The geometric layout of switch module 430 allows the light beam to travel with minimum distance and with minimum light energy loss. The distance between the fiber-lens matrix 425 and the mirror-actuator assembly 435 as well as the tilting angles for the reference mirror 440 and the mirror-actuator assembly 435 are specified to ensure a uniform and minimized traveling distance for the light beam. For a 1096-port photonic switch, for instance, a typical traveling distance is 1400 mm and the corresponding Raleigh beam diameter (which may expand by 40% over this distance) is about 1.66 mm. Collimator lenses with diameters of 1.8 mm may be chosen in this example to suppress the divergence and reduce the light loss due to the beam divergent issue.

The input and output mirrors of the photonic switch described above are controlled by an intelligent, software-based control system in one implementation. Feed forward and pre-shaping notch filtering may be utilized to eliminate unwanted dynamics of the mechanical structure in the mirror based photonic switch according to one embodiment of the present invention. The input sequence is time optimal in that it is designed to move the mirror from one radial position to another in minimum time. The filter is designed to shape this input sequence in order to prevent the fundamental resonance from vibrating during move and settling periods.

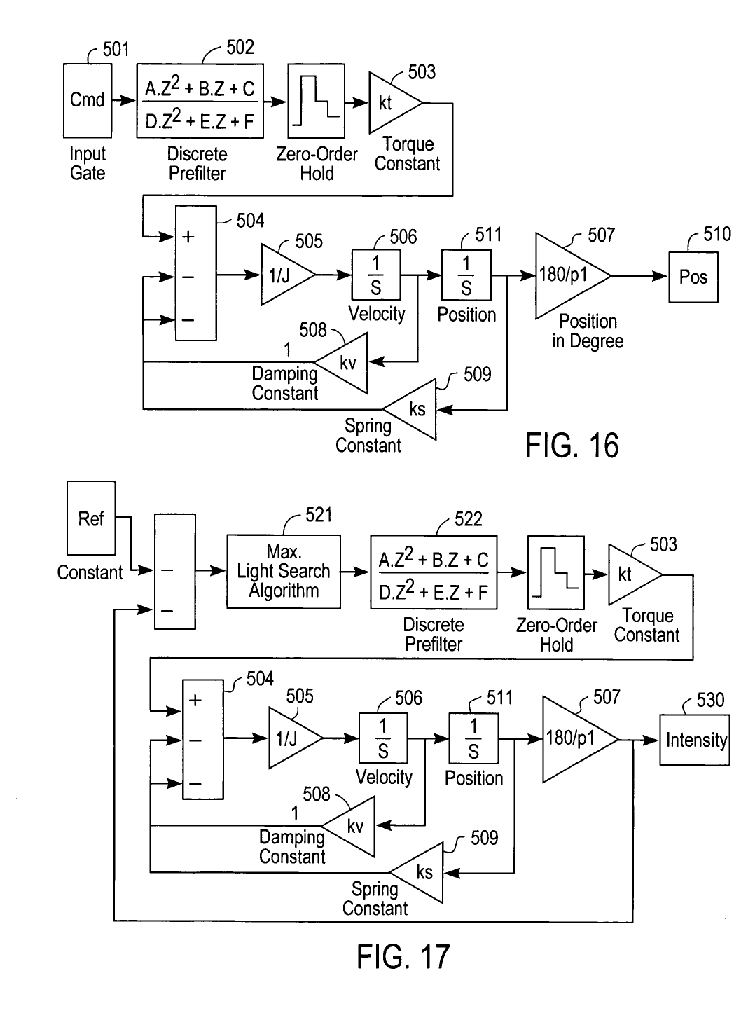

Referring now to FIG. 16 there is shown a block diagram of an open loop control system to position the mirrors of a photonic switch in accordance with one embodiment of the present invention. Using the system shown, the individual mirrors of the actuator-mirror matrix assembly (see FIGS. 1 and 2) are switched between various positions. Switching of mirror position is accomplished by appropriate application of current to the respective coils of the actuator-mirror matrix assemblies. Since the input and output mirrors each have two axes of movement (i.e., x & y), four coils are controlled to implement a switch.

An input command profile (block 501) produces the trajectory that the mirror has to follow to go from point A to point B, for example. Before the input command signal is applied to the coils it is conditioned and/or pre-filtered to reduce mechanical oscillations in accordance with the present invention. For example, a discrete pre-filter (block 502) is implemented as a biquad band reject filter with a transfer function given as:

G(z)=(A*s²+B*s+C)/(D*s²+E*s+F)

where “s” is the Laplace transform variable, and “A”-“F” are coefficients. This second-order equation may also be written in the discrete domain as

Y(z)/X(z)=(Aₙ*z²+Bₙz+Cₙ)/(A_{d}*z²+B_{d}*z+C_{d})

where “z” is the discrete domain equivalent of the Laplace variable “s”, and the “n” and “d” denote coefficients of the numerator and denominator, respectively. In the analog domain, the transfer function response of the filter may be expressed as:

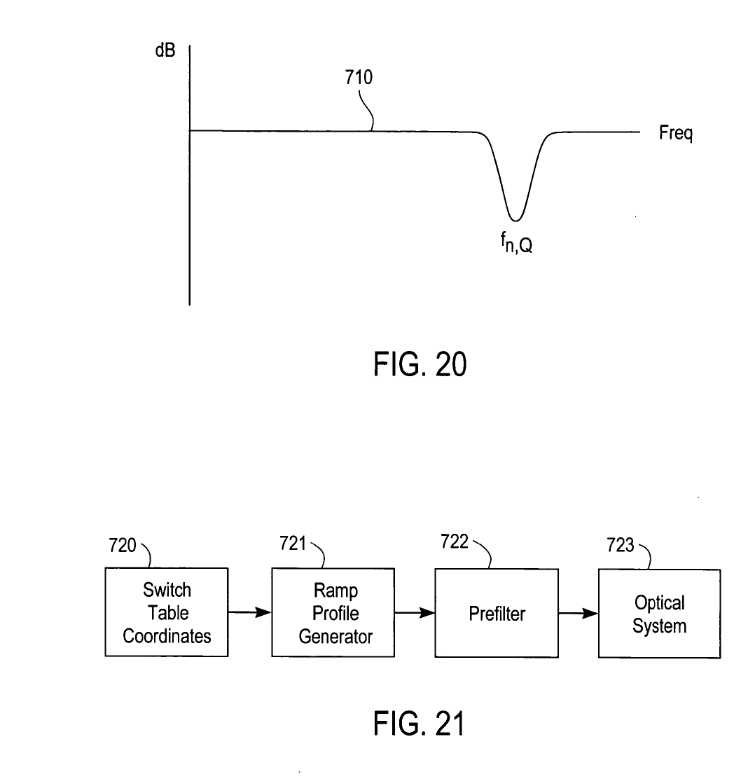

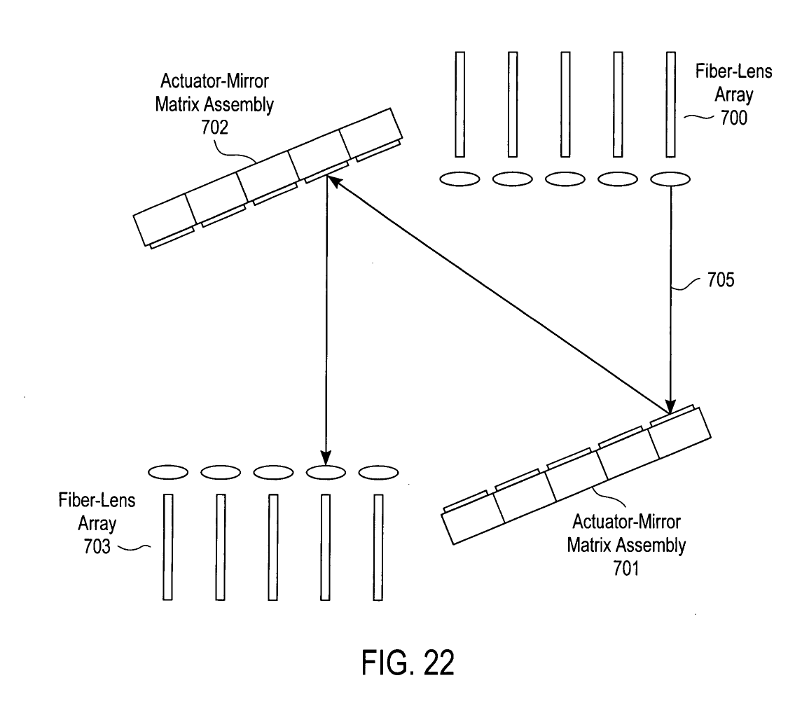

Y(s)/X(s)=((s²+Qₙ*s+(2πfₙ)²)/((s²+Q_{d}*s+(2πfₙ)²)

where “fₙ” is the resonance frequency and “Q” is a parameter representing the width or skirt of the filter response (Qₙ is the numerator value, and Q_{d} is the denominator value). An exemplary notch filter frequency response 710 is shown in FIG. 20.

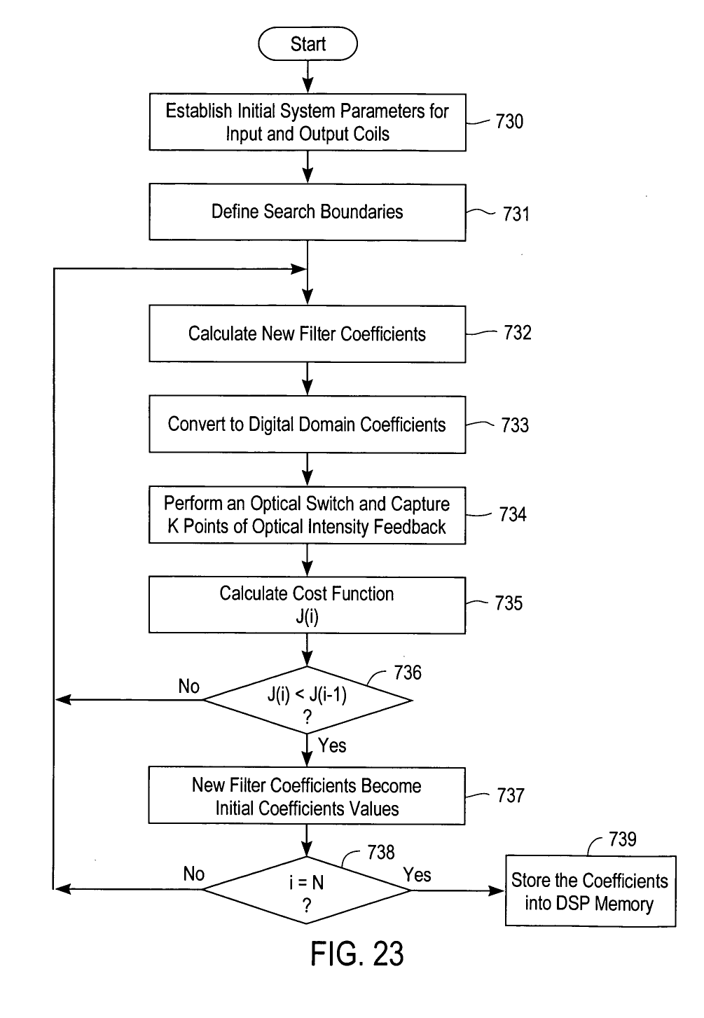

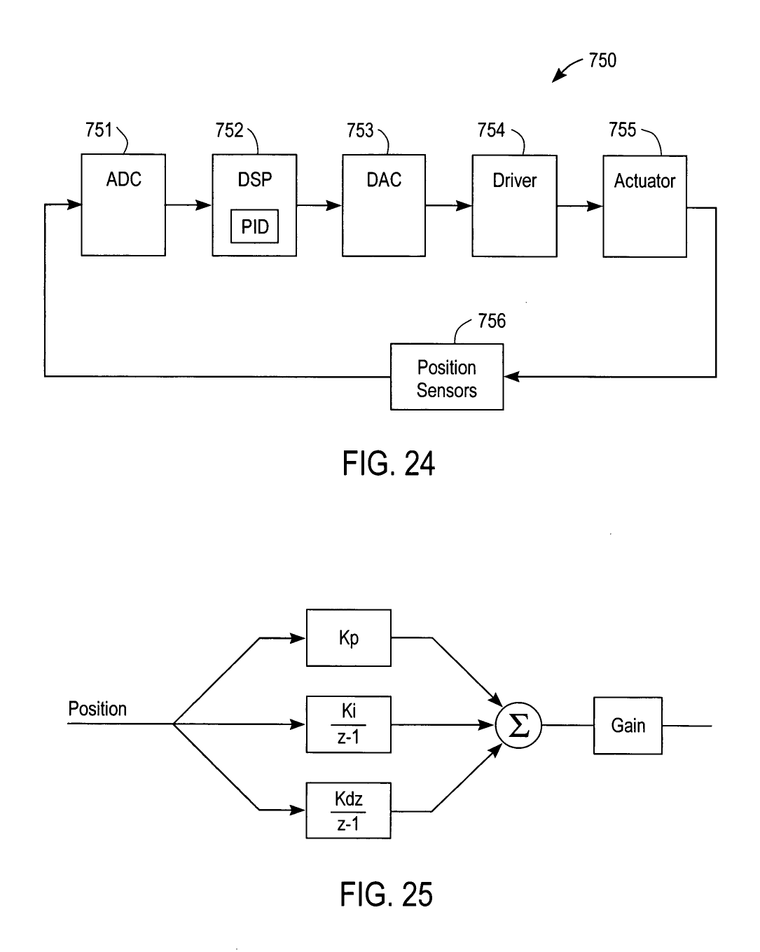

As described in more detail below, pre-filter 502 may be utilized in combination with a ramp profile generator to eliminate unwanted oscillations of the mirrors in the actuator-mirror matrix assembly of an all-optical switch. FIG. 19 is a plot that shows the beneficial effect of conditioning the input command signal used to position the mirrors of an all-optical switch fabric. Waveform 490 represents the input command profile of the original mirror position signal, i.e., without shaping and pre-filtering. Waveform 491 is the response with shaping and pre-filtering. In FIG. 19, the vertical axis is the mirror position (in degrees) and the horizontal axis is time (in seconds). A comparison of the two position responses shown in FIG. 19 illustrates the considerable improvement provided by the control system of the present invention. As can be seen, curve 491 of FIG. 23 has a fast, smooth switching response over the prior art approach represented by response curve 490.

Continuing with the control system circuit of FIG. 16, torque constant block 503 provides a gain that converts current into torque. The output of block 503 is coupled to the “+” input of summing block 504. The “−” inputs to block 504 are provided from the feedback outputs of blocks 509 and 508, which provide the responses due to the spring constant of the gimbal and the friction of the gimbal, both of which act to oppose the movement of the mirror. For example, block 508 provides a damping gain (kv) that converts velocity into a torque term that is subtracted from the input torque term generated by block 503. Similarly, block 509 provides a damping gain that converts position into a torque term subtracted from the input torque.

The output of summing block 504 is coupled to inertia conversion block 505, which converts torque into acceleration expressed in radians/(seconds)². Inertia is converted into velocity (radians/second) by block 511. At block 507 radians are converted into degrees, with the output representing the signal to achieve a desired mirror position in the switching mechanism (shown as block 510).

Referring now to FIG. 17 there is shown a block diagram for open loop control of mirror position for a photonic switch mechanism in accordance with another embodiment of the present invention. Note that in a particular embodiment, a portion (or all) of the component control circuitry may be physically located behind the actuator-mirror assemblies. FIG. 16 shows an open loop block diagram with a discrete pre-filter 502 to remove unwanted mechanical resonances. FIG. 17, on the other hand, shows a feedback mechanism that measures the light intensity and feeds it back to the discrete filter (block 522) using a scanning algorithm of compensation block 521.

The algorithm functions to search and detect maximum light intensity in an all-optical switch having one input port and one output port, each port has two axes. The algorithm generates a spherical scan structure for three of the four axes, and a linear scan for the fourth, in order to find the optimum coordinates where the light intensity transmitted through the switch is maximum (insertion losses minimum). As commands are generated for the four axes, a portion of the light intensity output from the switch is read. If the current reading is larger than a previous reading, the algorithm stores the current reading and discards the previous one. Every time a new local maximum is found, the algorithm shifts the center of the sphere to the new coordinates. The search starts with a fixed radius and a fixed step.

As the program progresses, both the radius and the step become incrementally smaller until a desired reading is reached. For instance, the desired reading may be in terms of insertion loss measured in decibels (dB). During operation of the switch, the calibration values (i.e., coordinates) may be used to position the switch at the correct coordinates. At this point, the algorithm program may enter a tracing mode, where it attempts to maintain the maximum light intensity by monitoring light intensity and entering into a low-radius calibration scan should the reading fall below an established threshold level. It is appreciated that low radius calibration may be performed at different radii depending on the intensity difference between the sensed or monitored light and the maximum reading.

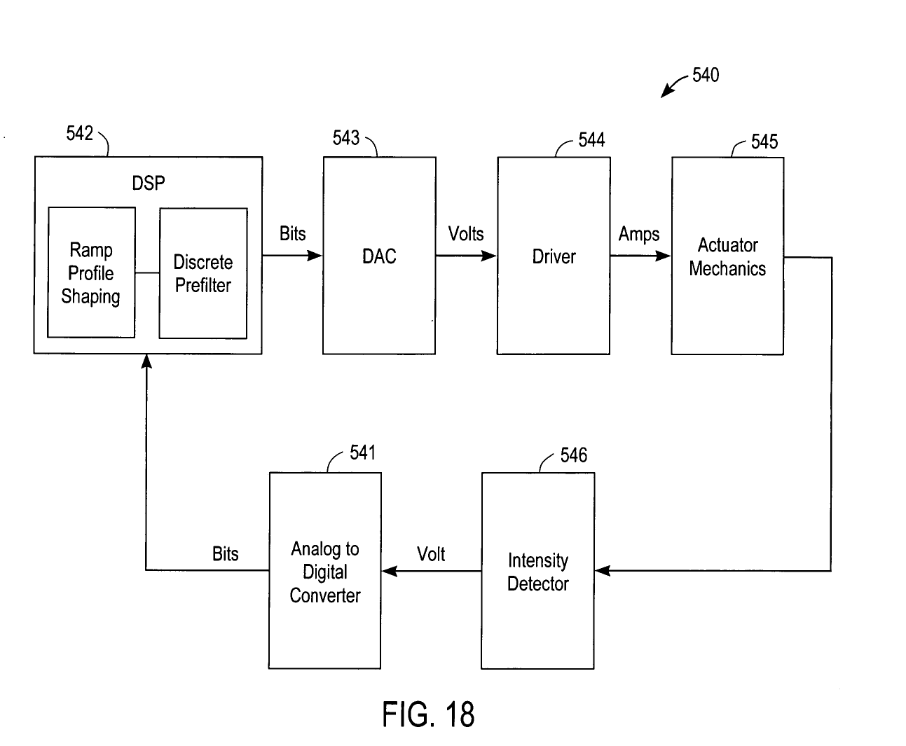

FIG. 18 is a high-level block diagram illustrating one possible implementation of the electronics that may be used for open loop control of a photonic switch according to the present invention. Note that the ramp profile shaping and discrete pre-filter functions may be realized using a digital signal processor (DSP) 542. DSP 542 may comprise a fixed-point processor that includes firmware to read feedback information from the analog-to-digital converter (ADC) 541. Optical sensors 546 produce an optical intensity output signal (in volts) that is digitized by ADC 541. That is, ADC 541 converts the analog intensity signal into a digital number that is received by DSP 542. The output of ADC 541 (in bits) is input into DSP 542 for shaping and pre-filtering of the command input signal prior to application to the coils of the input and output actuator-mirror assemblies. DSP 542 performs the necessary calculations and sends the appropriate position signal to the mirror actuators. DSP 541 outputs a digital command signal that is converted into an analog signal by digital-to-analog converter (DAC) 543. Drivers 544 convert the command signal into an analog signal (e.g., volts or amps) to control the actuator-mirror assemblies, represented by block 545.

The functional equivalent of the system of FIG. 18 is shown by the block diagram of FIG. 21. Block 720 represented a set of table coordinates for the optical switch that may be stored, for example, in memory (e.g., RAM or ROM). The memory locations may be embedded within the DSP. The table coordinates are the particular input and output mirror positions for any given configuration of the optical switch. The output of switch table coordinate block 720 is therefore a set of commands for implementing the x & y position coordinates of each mirror of the optical switch. These command coordinates are converted into ramp current commands applied to the mirror coils for the particular switch being implemented. According to one embodiment of the present invention, the ramp input is shaped (by ramp profile generator block 721) and pre-filtered (by pre-filter block 722) prior to application to the actuators of optical system 723. Shaping and pre-filtering of the input commands removes the various mechanical resonance components such that the system is more robust and switching time is significantly shortened.

In a particular embodiment, a method for generating the coefficients of the pre-filter and the slope of the ramp for each axis of both the input and output actuators of an optical switch is provided. FIG. 23 is a flowchart diagram of an algorithm for eliminating mechanical resonances in an optical switch in accordance with one embodiment of the present invention. The algorithm determines the optimal coefficients of the discrete pre-filter transfer function and slope of the ramp profile even in cases where the main parameters of the mechanics (i.e., fₙ and Q) vary as much as ±20%. It is appreciated that although the algorithm is preferably embodied as code stored in firmware within DSP 542, it may also be encoded in a machine-readable medium for execution by a processor associated with the optical system, or transmitted to the control electronics of the optical system via another medium (e.g., wireless, Internet, etc.).

The algorithm of FIG. 23 relies on a random neighborhood search that attempts to optimize the pre-filter coefficients and the slope, R, of the step input current applied to the actuator coils. The purpose of the algorithm is to eliminate or minimize mechanical oscillations in the mirror-actuator structures when the mirrors are moved to realize a particular switch. To achieve this result, the algorithm iteratively implements an optical switch in which a step input command signal is applied to the coils of the input and output mirrors. Each time, the resulting optical intensity output is observed, and the ramp profile and pre-filtering coefficients that shape the command signal are randomly changed, within certain parametric constraints. The new optical intensity output is then observed and compared against the previous result. The idea is to randomly step through different input command signal parameters within a constraint field and measure the output for each set or combination. If a given set of parameters yields an output response that is better than a previous best result, that parameter set becomes the origin or starting point for a new random neighborhood search process. After a certain number of iterations, the algorithm eventually converges on a set of pre-filter coefficients and ramp slope to shape the input command profile in a way that produces an optimal output result (i.e., eliminating or minimizing oscillations).

The algorithm shown in FIG. 23 starts with the establishment of a set of initial system parameters, as indicated in block 730. In the embodiment described, these initial system parameters include:

f_{n init}=[f_{Xi} f_{Yi} f_{Xo} f_{Yo}]

Q_{n init}=[Q_{nXi} Q_{nYi} Q_{nXo} Q_{nYo}]

Q_{d init}=[Q_{dXi} Q_{dYi} Q_{dXo} Q_{dYo}]

Rᵢₙᵢₜ=[R_{Xi} R_{Yi} R_{Xo} R_{Yo}]

N=number of iterations

where Xᵢ, Yᵢ and Xₒ, Yₒ represent the position coordinates for the respective input and output coils for a particular switch. It is thus appreciated that because a given switch requires current be applied to four different coils, the parameters fₙ, Qₙ, Q_{d}, R, each have four components.

Next, in block 731, the search boundaries are defined as follows:

fₘᵢₙ<fₙ<fₘₐₓ

Q_{n min}<Qₙ<Q_{n max}

Q_{d min}<Q_{d}<Q_{d max}

Rₘᵢₙ<R<Rₘₐₓ

By way of example, the initial frequency response, fₙ, may be set to be 100 Hz, with fₘᵢₙ and fₘₐₓ set to 80 Hz and 120 Hz, respectively (e.g., ±20%).

After the initial parameters and search boundaries have been established, the algorithm enters an iterative loop, where the number of iterations, N, has been determined in step 730. For each iteration (i) of the loop, the steps shown in blocks 732-737 are performed. First, new filter coefficients and ramp slope are calculated utilizing a random neighborhood search process, as indicated below.

fₙ=f_{n init}(1+2*fₛₜₑₚ*(rand[1,4]−0.5))

Qₙ=Q_{n init}(1+2*Q_{n step}*(rand[1,4]−0.5))

Q_{d}=Q_{d init}(1+2*Q_{d step}*(rand[1,4]−0.5))

R=Rᵢₙᵢₜ(1+2*Rₛₜₑₚ*(rand[1,4]−0.5))

where rand[1,4] is a random number from 1 to 4 and fₛₜₑₚ, Q_{n step}, Q_{d step}, and Rₛₜₑₚ each represent a predetermined small step value that weights the random number. In other words, at block 732 in the flowchart of FIG. 23 new filter coefficient and ramp slope values are computed based on the initial parameter values and a randomly generated number. The random number produces a small incremental change from the initial value.

Practitioners in the art will appreciate that the algorithm of the present invention is not restricted to a given step value or the particular random number range given by the above equations. That is, these values may vary arbitrarily, or based on the mechanical properties of the particular system or plant under control.

Once new filter coefficients have been calculated by the above equations, a subroutine program is called to convert the coefficients into their digital domain (i.e., z-domain) equivalents. This is shown occurring in FIG. 23 in block 733. In other words, the conversion program calculates Aₙ, Bₙ, Cₙ and A_{d}, B_{d}, C_{d} values based on the fₙ, Qₙ, Q_{d}, values computed above. A number of different programs may be utilized for the conversion. By way of example, one such program is shown in the code listing provided at the end of this specification.

Following conversion of the coefficients to the discrete domain, the DSP generates a digital command signal having a shape determined by the calculated coefficient and ramp slope values. This input command signal is then applied to the optical system to implement a switch. The optical intensity feedback response to the input command signal is then captured, as indicated by block 734. In the embodiment described, 128 data points of the output response curve (e.g., curve 491 of FIG. 19) are captured, each data point being separated by one millisecond intervals.

After the switch has been implemented and a response curve generated, the next step (block 735) is to calculate a cost function J(i), which basically provides an indication of how far the response curve is from an ideal response (i.e., no oscillations). A variety of cost function equations may be employed for this purpose. In one embodiment, the cost function equation is given as:

J(i)=((K−1)*Vₘₐₓ−ADCₛᵤₘ))²/K

where K is the number of data points collected (e.g., 128) Vₘₐₓ is the final response curve value after settling (e.g. in volts), and ADCₛᵤₘ is a summation of each of the data point values. For the cost function equation given above, the smaller the value of J(i), the smaller and fewer the number of oscillations in the optical intensity feedback response.

For each iteration of the loop, the newly calculated cost function J(i) is compared to the previous cost function value J(i−1). This comparison is shown taking place at decision block 736 in FIG. 23. If the new cost function value is less than the value computed for the previous iteration, the program designates the new pre-filter coefficients and ramp slope value as the initial values for the next iteration of the loop (block 737). If the new cost function value is not less than the value computed for the previous iteration, the program starts the next cycle with the old initial values from the previous iteration cycle. Of course, for each iteration a different random number is likely generated for each of the parameters, which will produce a new set of pre-filter coefficient and ramp slope values for shaping the input command signal. Note that this is true regardless of the initial parameter values remain unchanged.

The concept of the present invention, therefore, is to search for a set of coefficients that produces a best result (no oscillations) by randomly “walking” about the neighborhood established by a set of initial parametric values and certain boundary constraints. If a better result is achieved for a given iteration, the initial parameters are “reset” to the calculated values that produced that result. The random walk then continues about the newly calculated parameter set to determine whether an even better result can be achieved.

After all N iterations (e.g., N=50) of the switch loop have been completed (block 738) the combination of ramp slope and pre-filter coefficients that produced the best result, i.e., minimized mechanical oscillations, is stored in memory in the DSP. Memory locations external to the DSP may also be utilized.

Practitioners in the art will appreciate that the algorithm described above may be executed at the factory as a calibration routine prior to shipment of the optical system to a customer. In addition, the algorithm may be invoked by the end user as a maintenance routine to compensate for new environmental conditions or other changes to the mechanical components of the optical system.

FIG. 26 shows an example of a folded, matrix switch according to another embodiment of the present invention. An input fiber-lens array 700 is shown directing a light beam 705 to a first actuator-mirror matrix assembly 701, which directs beam 705 to a second actuator-mirror matrix assembly 702. Assembly 702 redirects light beam 702 to one of the fibers of output fiber-lens array 703.

The following is an example code listing of a coefficient conversion program utilized in one embodiment of the invention:

% notch1.m is a MATLAB program for design of digital notch filter
% The program requires notch frequency (fn), Q, and sample time (T)
% The program uses bi-quad filter design in s domain and then converts it
% to Z domain using bilinear transformation.
% Mansur Kiadeh © Lightbay Networks, Corp. 2001-2004 (17 U.S.C. § 401)
pause
echo off
format
%
% in s domain N(s) = (a2.s\hat{ }2 + a1.s + a0)/(b2.s\hat{ }2 + b1.s + b0)
% in z domain N(z) = (c2.z\hat{ }2 + c1.z + c0)/(d2.z\hat{ }2 + d1.z + d0)
%
fn=100;
q=1;
qn=1000;
atn=10;
T=50e−6;
%%%%%%%% BILINEAR TRANSFORMATION %%%%%%%%%
wn=2*pi*fn;
a2=1;
a1=2*wn/qn;
a0=wn\hat{ }2;
b2=1*(10\hat{ }(atn/20)); %
b1=2*wn/q;
b0=wn\hat{ }2;
numc=[a2 a1 a0];
denc=[b2 b1 b0];
%%%%%%%%%%%%%% pre-warping%%%%%%%%
wp=(2/Tn)*tan(wn*Tn/2);
a2=(wn/wp)\hat{ }2*a2;
a1=(wn/wp)*a1;
b2=(wn/wp)\hat{ }2*b2;
b1=(wn/wp)*b1;
c2=(4*a2/Tn\hat{ }2) + 2*a1/Tn + a0;
c1=−(8*a2/Tn\hat{ }2) + 2*a0;
c0=(4*a2/Tn\hat{ }2) − 2*a1/Tn + a0;
d2 = (4*b2/Tn\hat{ }2) + 2*b1/Tn + b0;
d1 = −(8*b2/Tn\hat{ }2) + 2*b0;
d0 = (4*b2/Tn\hat{ }2) −2*b1/Tn + b0;
%%%%% Digital notch coefficients %%%%%%%
An1=c2/d2;
Bn1=c1/d2;
Cn1=c0/d2;
Dn1=d1/d2;
En1=d0/d2;
%
%
w = logspace(2,1.1*pi,500);
f=w/(2*pi);
nnum=[c2/d2 c1/d2 c0/d2];
nden=[1 d1/d2 d0/d2];
[mag,phase]=dbode(nnum,nden,Tn,w);
[mg1k,ph1k]=dbode(nnum,nden,Tn,2*pi*1000);
%f=w/(2*pi*T);
%figure(1),
subplot(211),
axis([10 2000 −40 10]);
semilogx(f,20*log10(mag)), grid,
title(‘Discrete Notch Filter’),
xlabel(‘Frequency in Hz’),
ylabel(‘Magnitude in dB’),
text(.15,.15,[‘fn=’,num2str(fn),‘q=’,num2str(q),‘phase at 1000Hz=’,num2str(ph1k)],‘sc’)
%text(100,−5,[‘phase loss at 1000 Hz =’,num2str(ph1k)])
subplot(212),
semilogx(f,phase), grid,
xlabel(‘Frequency in Hz’),
ylabel(‘Phase in degrs’)
pause,clc
disp(‘Notch filter difference equation:’)
disp(‘y(n) = An1*x(n) + Bn1*x(n−1) + Cn1*x(n−2) − Dn1*y(n−1) − En1*y(n−2)’)
disp(‘ where:’)
disp([‘ An1=’,num2str(An1),‘ Bn1=’,num2str(Bn1),‘ Cn1=’,num2str(Cn1)])
disp(‘’)
disp(‘ and’)
disp([‘ Dn1=’,num2str(Dn1),‘ En1=’,num2str(En1)])
disp(‘ In q12 format:’)
format bank
K1=An1*2\hat{ }12
K2=Bn1*2\hat{ }12
K3=Cn1*2\hat{ }12
G1=Dn1*2\hat{ }12
G2=En1*2\hat{ }12
%disp(‘press enter to return to menu’)
pause

I claim:

1. A method for reducing oscillations in an optical switch comprising:
(a) establishing a set of initial parameter values that shape an input command signal, the input command signal controlling input/output mirror actuators of the optical switch;
(b) calculating a set of new parameter values of the input command signal in accordance with an algorithm that randomly varies each initial parameter value within certain constraints;
(c) applying the input command signal to the input/output mirror actuators to produce a response by the optical switch;
(d) calculating a cost function value indicative of oscillations present in the response;
(e) comparing the cost function value to a previous cost function value, if the cost function value is less than the previous cost function value,
(i) storing the new parameter values in a memory; and
(ii) designating the new parameter values as the initial parameter values;
(f) iteratively repeating (b)-(e).

2. The method according to claim 1 wherein the new parameter values includes pre-filtering coefficients and a slope, R, of the input command signal.

3. The method of claim 2 wherein the cost function value, J(i), of an ith iteration is given as
J(i)=((K−1)*Vₘₐₓ−ADCₛᵤₘ))²/K
where K is a number of data points captured from the response, Vₘₐₓ is a final response value after settling, and ADCₛᵤₘ is a summation of data point values.

4. The method of claim 1 wherein the response is an optical intensity feedback response of the optical switch.

5. The method of claim 2 wherein the algorithm is embodied as code for execution on a digital signal processor.

6. The method of claim 5 wherein the set of initial parameter values includes:
f_{n init}=[f_{Xi} f_{Yi} f_{Xo} f_{Yo}]
Q_{n init}=[Q_{nXi} Q_{nYi} Q_{nXo} Q_{nYo}]
Q_{d init}=[Q_{dXi} Q_{dYi} Q_{dXo} Q_{dYo}]
Rᵢₙᵢₜ=[R_{Xi} R_{Yi} R_{Xo} R_{Yo}]
where Xᵢ, Yᵢ and Xₒ, Yₒ represent position coordinates for the input/output mirror actuators, respectively, of the optical switch, fₙ is a resonance frequency, and Qₙ and Q_{d} are respective numerator and denominator filter response parameters.

7. The method of claim 6 wherein the algorithm comprises a set of mathematical equations that includes:
fₙ=f_{n init}(1+2*fₛₜₑₚ*(rand[a, b]−c))
Qₙ=Q_{n init}(1+2*Q_{n step}*(rand[a, b]−c))
Q_{d}=Q_{d init}(1+2*Q_{d step}*(rand[a, b]−c))
R=Rᵢₙᵢₜ(1+2*Rₛₜₑₚ*(rand[a, b]−c))
where rand[a, b] is a random integer number between a and b, c is a real number, and fₛₜₑₚ, Q_{n step}, Q_{d step}, and Rₛₜₑₚ each represent a predetermined weight value.

8. The method of claim 7 wherein a, b, and c equal 1, 4, and 0.5, respectively.

9. A method for reducing oscillations in an optical switch comprising:
(a) generating an input command signal for controlling input/output mirror actuators of the optical switch, the input command signal being generated by a digital signal processor according to an algorithm that calculates a set of new parameter values to shape the input command signal by randomly varying a set of corresponding initial parameter values within certain constraints;
(b) converting the input command signal to an analog signal;
(c) applying the analog signal to the input/output mirror actuators;
(d) capturing data points from a feedback response of the optical switch;
(e) calculating a cost function value from the data points, the cost function value indicative of oscillations present in the feedback response;
(f) comparing the cost function value to a previous cost function value, if the cost function value is less than the previous cost function value,
(i) storing the new parameter values in a memory; and
(ii) designating the new parameter values as the corresponding initial parameter values for a next iteration;
(e) iteratively repeating (a)-(f) N times, where N is an integer.

10. The method according to claim 9 wherein the new parameter values includes pre-filtering coefficients and a slope, R, of the input command signal.

11. The method of claim 10 wherein the cost function value, J(i), of an ith iteration is given as
J(i)=((K−1)*Vₘₐₓ−ADCₛᵤₘ))²/K
where K is a number of data points captured from the output response, Vₘₐₓ is a final response value after settling, and ADCₛᵤₘ is a summation of data point values.

12. The method of claim 9 wherein the output response is an optical intensity output of the optical switch.

13. The method of claim 9 wherein the set of corresponding initial parameter values includes:
f_{n init}=[f_{Xi} f_{Yi} f_{Xo} f_{Yo}]
Q_{n init}=[Q_{nXi} Q_{nYi} Q_{nXo} Q_{nYo}]
Q_{d init}=[Q_{dXi} Q_{dYi} Q_{dXo} Q_{dYo}]
Rᵢₙᵢₜ=[R_{Xi} R_{Yi} R_{Xo} R_{Yo}]
where Xᵢ, Yᵢ and Xₒ, Yₒ represent position coordinates for the input/output mirror actuators, respectively, of the optical switch, fₙ is a resonance frequency, and Qₙ and Q_{d} are respective numerator and denominator filter response parameters.

14. The method of claim 13 wherein the algorithm comprises a set of mathematical equations that includes:
fₙ=f_{n init}(1+2*fₛₜₑₚ*(rand[a, b]−c))
Qₙ=Q_{n init}(1+2*Q_{n step}*(rand[a, b]−c))
Q_{d}=Q_{d init}(1+2*Q_{d step}*(rand[a, b]−c))
R=Rᵢₙᵢₜ(1+2*Rₛₜₑₚ*(rand[a, b]−c))
where rand[a, b] is a random integer number between a and b, c is a real number, and fₛₜₑₚ, Q_{n step}, Q_{d step}, and Rₛₜₑₚ each represent a predetermined weight value.

15. The method of claim 14 wherein a, b, and c equal 1, 4, and 0.5, respectively.

16. A control system for eliminating oscillations in an optical switch which includes input and output mirror-actuator assemblies, comprising:
a digital signal processor (DSP) to execute a program that generates an input command signal, the program calculating a set of new parameter values that shape the input command signal by randomly varying a set of corresponding initial parameter values within certain constraints;
a digital-to-analog converter (DAC) to convert the input command signal to an analog signal;
drivers coupled to receive the analog signal from the DAC and drive the input and output mirror-actuator assemblies in response thereto;
sensors to produce an optical intensity feedback response of the optical switch;
an analog-to-digital converter (ADC) to convert the optical intensity feedback response to a digital signal input to the DSP;
wherein the DSP is further operative to calculate a cost function value from the digital signal, the cost function value being indicative of oscillations present in the optical intensity feedback response, the DSP comparing the cost function value to a previous cost function value, if the cost function value is less than the previous cost function value the DSP storing the new parameter values in a memory and designating the new parameter values as the corresponding initial parameter values for a next iterative cycle of the program.

17. The control system of claim 16 wherein the new parameter values includes pre-filtering coefficients and a slope, R, of the input command signal.

18. The control system of claim 16 wherein the cost function value, J(i), of an ith iterative cycle is given as
J(i)=((K−1)*Vₘₐₓ−ADCₛᵤₘ))²/K
where K is a number of data points captured from the optical intensity feedback response, Vₘₐₓ is a final response value after settling, and ADCₛᵤₘ is a summation of data point values.

19. The control system of claim 16 wherein the set of corresponding initial parameter values includes:
f_{n init}=[f_{Xi} f_{Yi} f_{Xo} f_{Yo}]
Q_{n init}=[Q_{nXi} Q_{nYi} Q_{nXo} Q_{nYo}]
Q_{d init}=[Q_{dXi} Q_{dYi} Q_{dXo} Q_{dYo}]
Rᵢₙᵢₜ=[R_{Xi} R_{Yi} R_{Xo} R_{Yo}]
where Xᵢ, Yᵢ and Xₒ, Yₒ represent position coordinates for the input/output mirror actuators, respectively, of the optical switch, fₙ is a resonance frequency, and Qₙ and Q_{d} are respective numerator and denominator filter response parameters.

20. The control system of claim 19 wherein the program calculates a set of mathematical equations that includes:
fₙ=f_{n init}(1+2*fₛₜₑₚ*(rand[a, b]−c))
Qₙ=Q_{n init}(1+2*Q_{n step}*(rand[a, b]−c))
Q_{d}=Q_{d init}(1+2*Q_{d step}*(rand[a, b]−c))
R=Rᵢₙᵢₜ(1+2*Rₛₜₑₚ*(rand[a, b]−c))
where rand[a, b] is a random integer number between a and b, c is a real number, and fₛₜₑₚ, Q_{n step}, Q_{d step}, and Rₛₜₑₚ each represent a predetermined weight value.

21. The control system of claim 20 wherein a, b, and c equal 1, 4, and 0.5, respectively.
